(19) United States
(12) Patent Application Publication
(10) Pub. No.: US 2013/0013480 A1
(43) Pub. Date: Jan. 10, 2013

(54) OPERATION OF A MOBILE COMMUNICATION DEVICE

(76) Inventor: Nick Venter, Johannesburg (ZA)

(21) Appl. No.: 13/635,853

(22) PCT Filed: Mar. 18, 2011
(86) PCT No.: PCT/IB2011/051132

§ 371 Date: Sep. 18, 2012

(30) Foreign Application Priority Data
Mar. 18, 2010 (ZA) 2009/06513

(51) Int. Cl. G06Q 40/02

(52) U.S. Cl. 705/35

(57) ABSTRACT

A method of operating a mobile communication device to communicate with a remote server includes providing software on the mobile device to input data relating to a payment card, authenticating the data relating to the payment card with an authentication authority, and providing by means of the software at least means to selectively set permissions on the remote server in respect of an account associated with the card.

### CROSS-REFERENCE TO RELATED APPLICATIONS

This application claims the benefit under 35 U.S.C. §§119a-d to South Africa Application Serial No. 2009/06513 to the inventor, filed Mar. 18, 2010, and the benefit under 35 U.S.C. §365(b) to International Application Serial No. PCT/IB2011/051132, filed Mar. 18, 2011. The entire contents of each application are hereby incorporated by reference herein.

### BACKGROUND

1. Field

The example embodiments relate to a method, system and software to operate an account risk management system by means of a mobile communication device.

2. Related Art

Presently, a significant amount of fraud is perpetrated through unauthorized access to accounts such as bank and card accounts. The majority of this occurs as a result of stolen identity credentials and credit or debit cards being copied or “skimmed”.

While financial institutions, credit card associations and card issuers have deployed authentication security systems to prevent unauthorized access to payment instruments many are in-effective and others costly to implement. For example, Smart Cards, recognized as the most secure card payment technology to prevent card skimming, while effective are costly.

It is further believed that a significant amount of internet banking fraud and card fraud is committed as a result of log-in credentials or payment card details being compromised and thereafter used to transfer funds or for internet purchases, for unauthorized mail-order telephone-order purchases and card-present fraud.

Thus, there exists a need to increase the security on payment instruments and accounts that allow the account holder remote access to an authorization system through a simple and affordable method using devices and channels readily accessible to most account holders.

Most current fraud prevention efforts focus on a single challenge, e.g., EMV on counterfeit and 3D-Secure on Internet fraud, but none cover all financial channels. An efficient system would need to cover as many channels as possible with a single solution.

An account management system has been provided which at least partly overcomes the abovementioned problems, as described in international patent applications PCT/IB2007/055015 and PCT/IB2009/052590. This system described in these two applications relate to a centralized server which allows a card issuing financial institution, such as a bank, to allow access to its system from a mobile device by means of text messages, which in turn may then be used to control security features of a card. The system allows for the setting of permissions in respect of a payment card. Until now no system, method or software existed to make use of this ability with respect to mobile communications devices to allow more advanced control of the permissions possible with respect to this system.

### SUMMARY

An example embodiment is directed to a method of operating a mobile communication device to communicate with a remote server. The method includes providing by means of software operated on the mobile device means to input data relating to a payment card, authenticating the data relating to the payment card with an authentication authority, such as the financial institution that issued the payment card, activating the card for control by the software, and providing by means of the software at least means to selectively set permissions stored on the remote server in respect of transactions on the account associated with the payment card.

The authenticating of data relating to the card further includes transmitting a data carrying signal which includes data relating to at least the card number to the authentication authority, receiving on the mobile device a data carrying confirmation signal transmitted from the authentication authority to the mobile communication number associated with the card, the data signal including an authentication code, accessing the authenticating code by means of the software and transmitting, such as within a given or designated time from receiving the authentication code, from the mobile device a data carrying signal which includes at least the card number and the authentication code signal to the server, and storing the authentication code in storage means associated with the mobile device and associating the authentication code with at least the card number.

The method may further include activating or deactivating the card by setting permissions with respect to the account on the remote server, which operatively activates or deactivates the card for transactions in respect of the account.

The selectively activating or deactivating the card may further include providing input means on the device to select an “ON” or “OFF” status, in which selecting “ON” sets the status of the card as activated and selecting “OFF” sets the status of the card as deactivated, which sets the corresponding permissions in respect of the associated account on the remote server to allow or disallow such a transaction on the remote server.

The method may further include providing selection means to operate the mobile device to input a selection in respect of the activation or deactivation of the card with respect to given or designated utilization areas, the utilization areas including point of sale, automatic teller machine, online transactions, and geographical limitations; preferably comprising the provision of input means to select an “ON” or “OFF” status in respect of each of the utilization areas.

There is further provided for the method to include providing selection means to operate the mobile device to transmit a data carrying signal to the server requesting a status update in respect of account balances of an account associated with the card, such as including a ledger balance and an available balance, receiving a data carrying signal from the server which includes data relating to the account balances, and processing the data to display the account balances on the display screen of the mobile device.

The method may further include providing selection means to operate the mobile device to transmit a data carrying signal to the server requesting a status update in respect of the current account limits of an account associated with the card, preferably including daily and monthly account limits, receiving a data carrying signal from the server which includes data relating to the current account limits, and processing the data to display the current account limits on the display screen of the mobile device.

There is further provided for at least part of the data carrying signals to be transmitted in the form of short message service signals.

The example embodiment further extends to include a mobile communication device which is operable by means of the iOS™ operating system from the Apple™ company, alternatively the Symbian™, Android™ or Blackberry™ mobile communication device operating systems to implement the method described above.

According to a further feature of the example embodiments there is provided a system which comprises a mobile communication device as defined above and at least a server configured to complimentary operate with respect to the mobile communication device to implement the method described above.

According to a further feature of the example embodiments there is provided software operable on a mobile communication device to operate the above method.

According to a further feature of the example embodiments there is provided a mobile communication device configured to operate a set of instructions to perform the above method.

These and other features of the example embodiments are described in more detail below.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a screen shot of a main card input menu.

FIG. 2 is a screen shot of a menu for a card number input.

FIG. 3 is a screen shot of a menu to select automatic card ON/OFF status.

FIG. 4 is a screen shot of a menu which shows a card awaiting authorisation.

FIG. 5 is a screen shot of a menu showing active and inactive cards.

FIG. 6 is a screen shot of a menu showing details of an inactive card.

FIG. 7 is a screen shot of a menu showing details of an active card.

FIG. 8 is a screen shot of a menu showing active utilization areas of a card.

FIG. 9 is a screen shot of a menu showing active and inactive utilization areas of a card.

FIG. 10 is a screen shot of a menu showing the inactive utilization status of the card in respect of a number of countries.

FIG. 11 is a screen shot of a menu showing inactive and active utilization status of the card in respect of a number of countries.

FIG. 12 is a screen shot of a menu showing the daily account limits in respect of an account associated with the card.

FIG. 13 is a screen shot of a menu showing the user changing an account limit.

FIG. 14 is a screen shot of a menu showing current balances in respect of an account associated with the card.

FIG. 15 is a screen shot of a menu showing the stolen card button.

FIG. 16 is a screen shot of a menu showing the confirmation message displayed before a stolen card is reported as such.

FIG. 17 is a screen shot of a menu showing the selection of listed cards to edit them.

FIG. 18 is a screen shot of a menu showing a card being deleted.

### DETAILED DESCRIPTION

As to be described in more detail hereafter, the example embodiments provide a method, system and software which at least partly overcome the abovementioned problems. The drawings show the display screen of a mobile communication device which is available under the brand name “iPhone®” from the United States “Apple®” company.

When reference is made to “pressing a button” on a screen, what is meant by that is that an area on the display screen that displays a graphic of a button or a selection field is touched to instruct the device to execute the respective command. Although these are not buttons in the conventional sense of the word, they act as touch screen buttons that allow a user to input a selection merely by touching an appropriate area of a display screen. In the case of the iPhone the “button” is slidable between the ON and OFF positions and vice versa, but may also just be touched to achieve the same result. Similarly, when the word “scrolling” is used, the user will drag his finger across the screen to scroll the screen in that direction.

In this specification hereafter, the term “accounts” may refer to money accounts such as savings accounts, call accounts, cheque accounts, current accounts, association branded or proprietary credit or debit card accounts, accounts with a merchant or a service provider which reflect a monetary value.

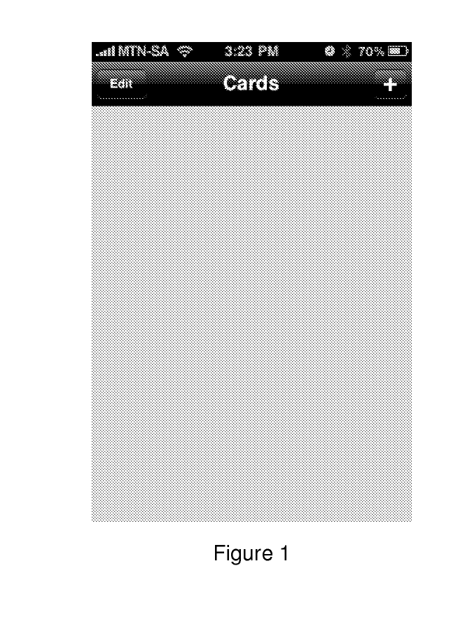

FIG. 1 is a screen shot of a mobile communication device, in this instance an iPhone 3GS operating the Apple 3.1 operating system, a version of the Apple mobile communication device “iOS™” operating system. It shows a main card input menu where a user is prompted to add a new payment card to the system.

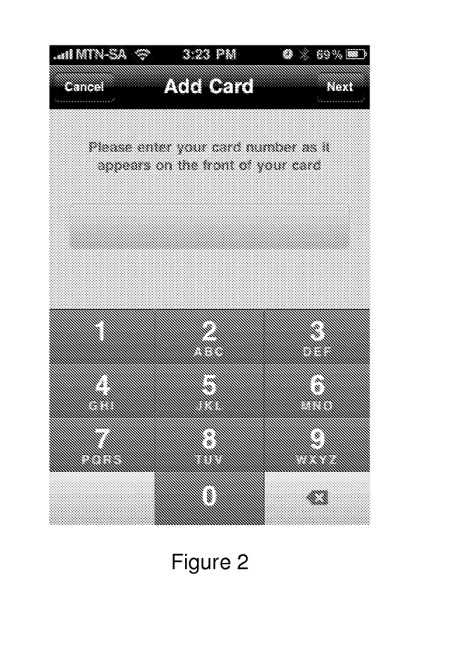

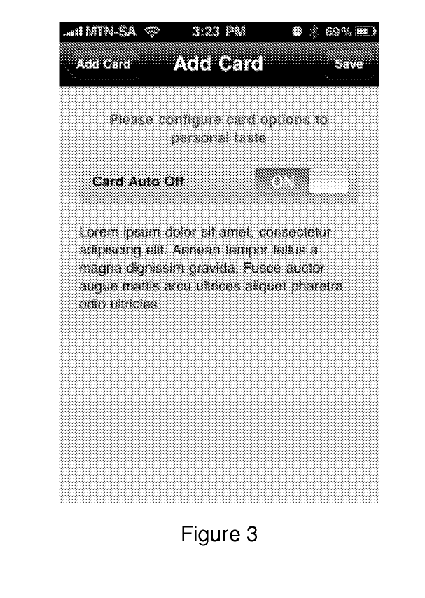

A card is added by touching the “+” button at the top right of the screen. This opens a menu, shown in FIG. 2, which prompts the user to enter the card number as it appears on the front of the card. The user enters the card number and touches the “Next” button, which opens the menu shown in FIG. 3.

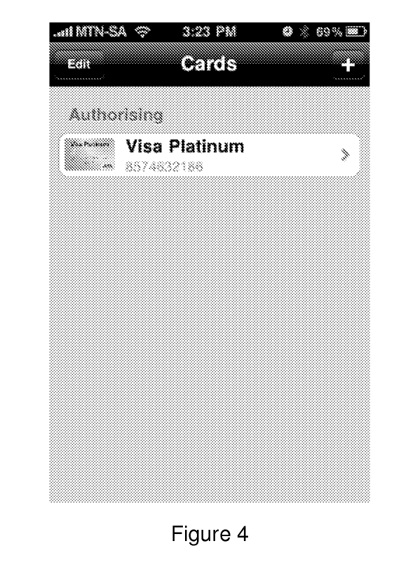

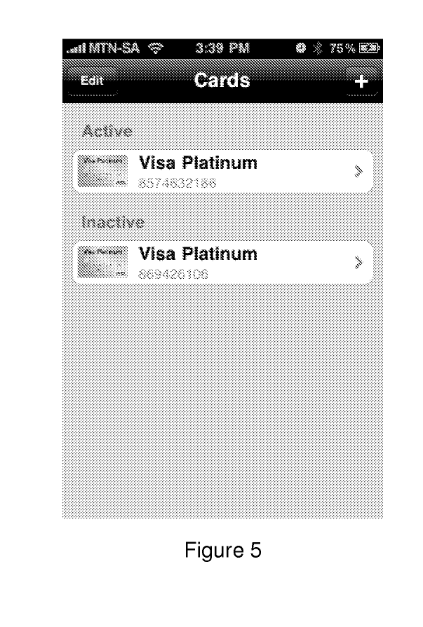

In this menu the user is prompted to select whether the status of the card is set as automatic on or automatic off. If the card is set as “OFF”, then the card will be listed but it will be awaiting authorisation, as shown in FIG. 4. Once a card has been authorised for the first time, it is shown as active or inactive, depending on whether the card is set as “ON” or “OFF”, as shown in FIG. 5.

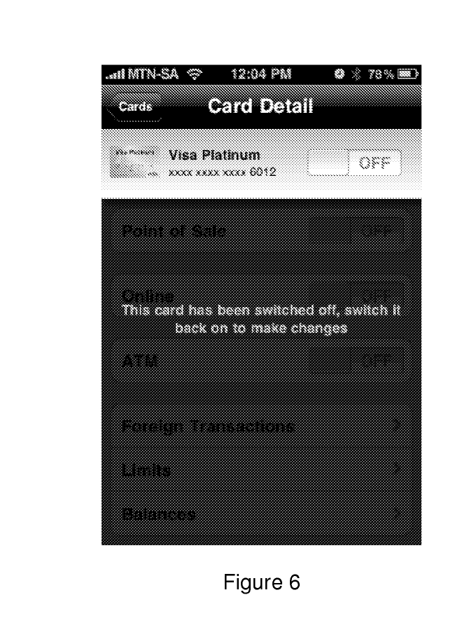

To set the status of a card to “ON” or “OFF”, the card itself is selected by touching the bar showing its detail. This is shown in FIG. 5. This opens a menu which relates to the specific card. If the status of the card is set to off, then the screen shown in FIG. 6 is displayed. The user is prompted to activate, i.e. turn “ON”, the card to make changes to its status. The card is turned “ON” (activated), by touching the slider button shown in FIG. 6, which slides the button from “OFF” to “ON”.

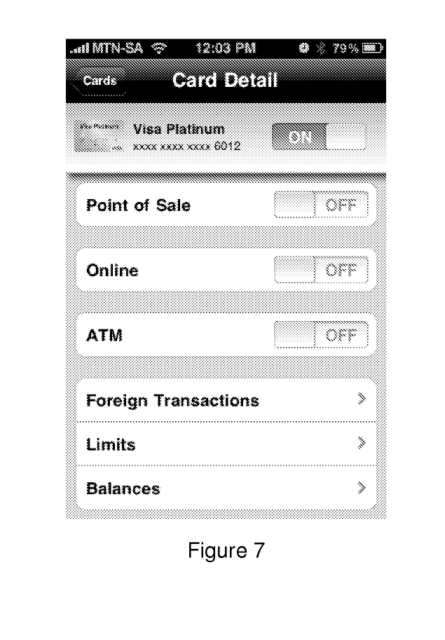

Activating the card opens a menu which shows details of the card, as shown in FIG. 7. At the top the status of the card is now shown as “ON”.

Immediately below the card number listing are listed utilization areas in respect of which the status of the card may be changed, namely “Point of Sale ”, “Online” and “ATM”. Each of these may be turned “ON” or “OFF”. In FIG. 7 they are shown as set to “OFF”.

The “Point of Sale” area relates to sales at most shops where a card may be swiped at a point of sale (“POS”) device. In some instances a user may be prompted to enter a code in respect of such sales, for example where a debit card is used, but in most instances the swipe of the card and the user's signature on the payment slip printed from this POS device is sufficient to allow the transaction to be processed. Typically signatures are not thoroughly checked at POS devices, so a card swipe is usually enough to process a transaction. This makes this a very risky area in respect of card fraud.

The “Online” area relates to sales over the Internet where card details are transmitted over an internet connection to an online service. Typically in such instances the 3 digit CVC security code at the back of the payment card has to be submitted as well to authorise the transaction from the card. In such cases a user's signature is not required.

The “ATM” area relates to use of a card at an automatic teller machine or cash machine. In cases such as this the card has to be physically input into the ATM and then, once prompted, the card holder has to input a security code to authorise transactions from the card.

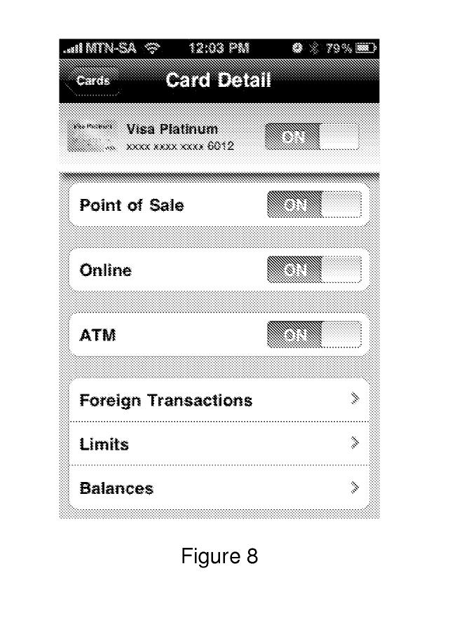

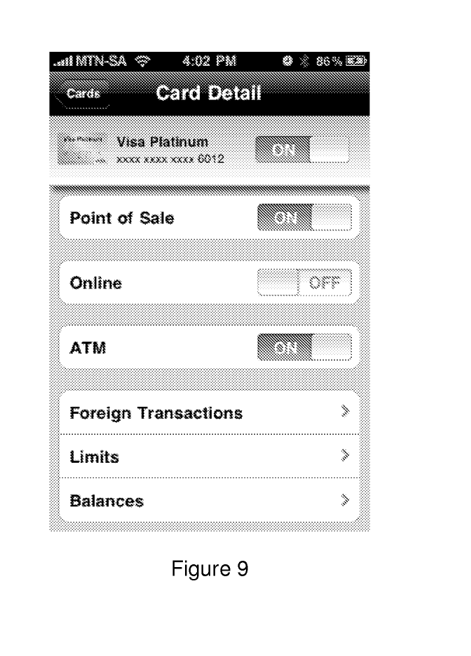

All of these may be independently switched “ON” or “OFF” by touching the “ON” or “OFF” in respect of each utilization area, as shown in FIGS. 8 and 9.

Immediately below the three utilization areas selection blocks there is displayed a selection block which includes selection buttons in respect of “Foreign Transactions”, “Limits”, and “Balances”.

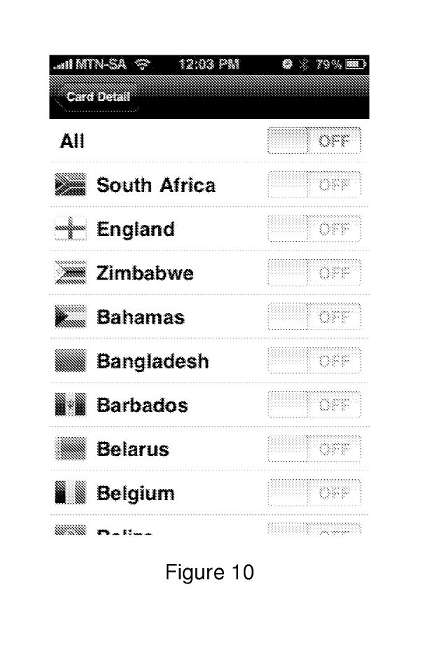

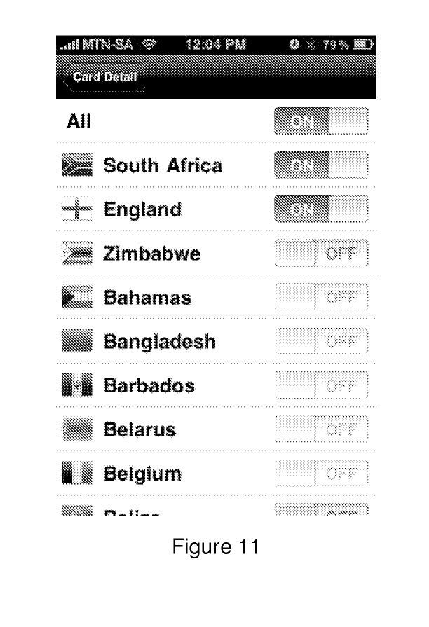

Selection of the “Foreign Transactions” button opens a menu, shown in FIG. 10, which displays a number of countries in respect of which the utilization status of the card may be changed. At the top is a field marked “All” which may be turned “ON” or “OFF”. If this is set to “OFF” none of the listed countries below it are active. If the “All” status is set to “ON”, then the status of each country may be set to “ON” or “OFF” individually, as shown in FIG. 11, where the card has been activated for South Africa and England. Each country is identified by name and its national flag.

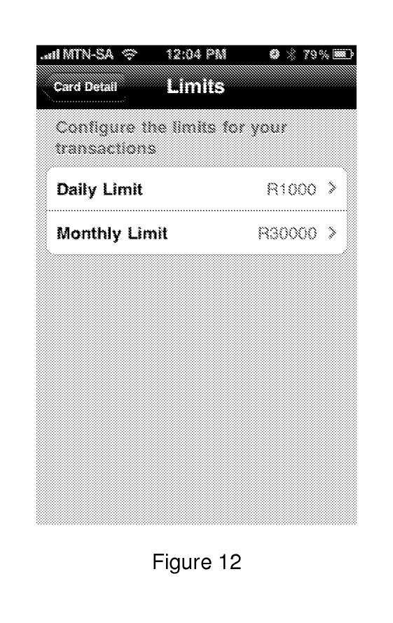

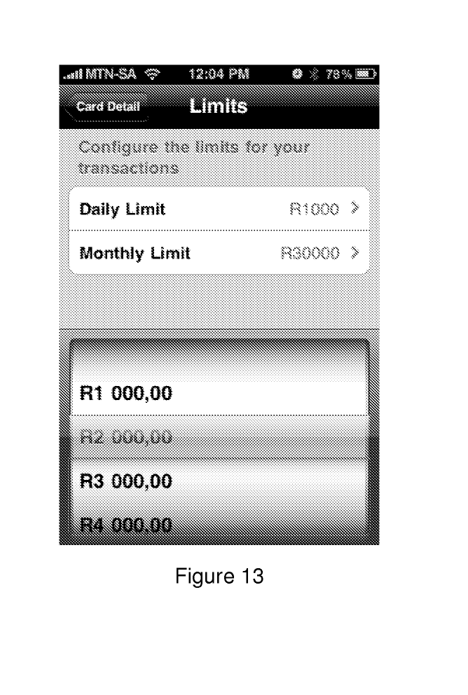

Selection of the “Limits” button, back on the main card detail menu (refer to FIG. 9), opens a menu which displays the daily and monthly transaction limits in respect of the card in the base currency of the card, in this instance South African Rand. This is shown in FIG. 12. These values may be changed by touching the respective area, which opens a value selection barrel at the bottom of the screen, as shown in FIG. 13, and selecting a new value by “rolling” the barrel to the new value.

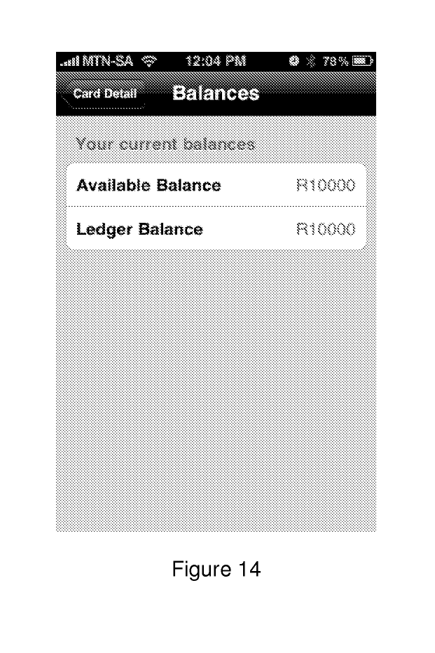

Selection of the “Balances” button, also back on the main card detail menu (refer to FIG. 9), opens a menu which displays the current balances in respect of the account associated with the payment card. The balances include the ledger balance and the available balance. This is shown in FIG. 14. These can obviously not be changed since they simply reflect the current state of affairs with respect to the account associated with the card.

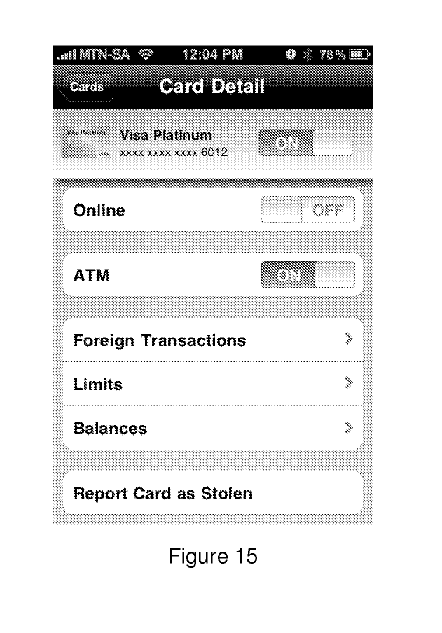

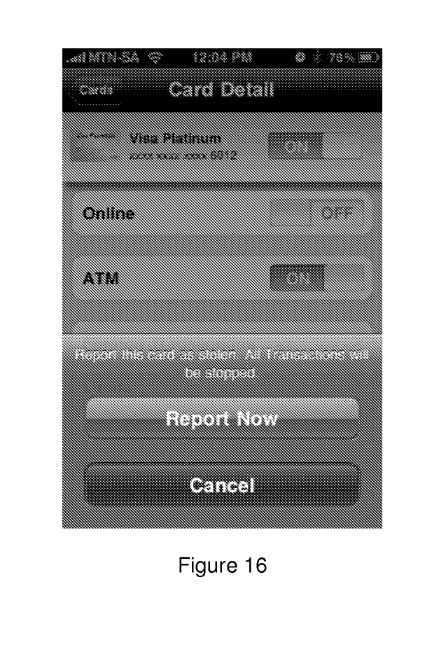

On the main card detail menu there is another input area below the balances input area. This is located by scrolling down on the screen. This input block includes a button which reads “Report Card as Stolen”, as shown in FIG. 15. When this button is pressed a menu as shown in FIG. 16 is displayed. This allows a person to report a card as stolen by pressing the “Report Now” button. If the person does not wish to proceed the “Cancel” button may be pressed.

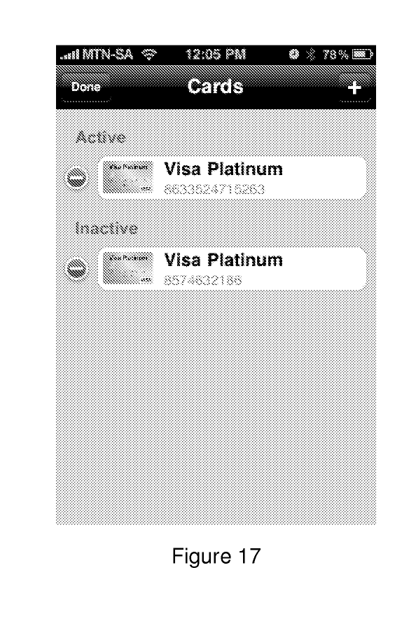

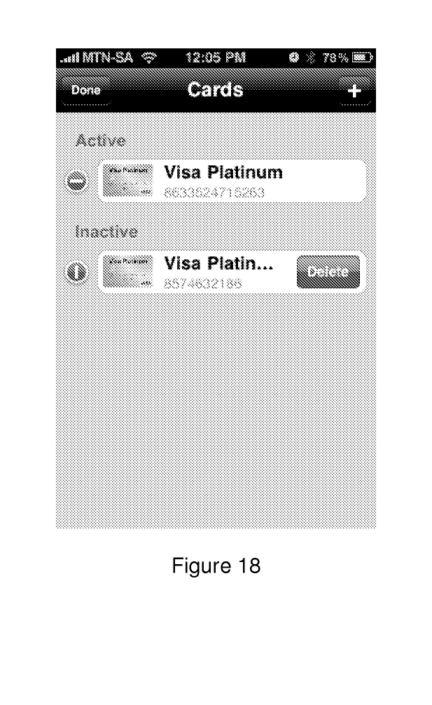

If the user has to delete a card, which may happen when a card is renewed and replaced by a new card with a new number, the user presses the “Edit” button at the top left of the main screen, as shown in FIG. 5. This opens a button to the left next to each card detail block which resembles a no-entry-road sign. This button may be pressed to delete the specific card. If this button is pressed, the button detail changes by moving the white horizontal line in the button to be vertically arranged, and a “Delete” button appears to the right of the card detail. When this is pressed the card is deleted. This is shown in FIGS. 17 and 18 respectively. Once a card has been deleted, even if by mistake, it has to be authorised and activated again as explained at the outset.

By making use of the system, method and software disclosed in this specification a user is able to selectively control the security of his payment cards. The user may choose when he wishes to activate a card, which makes it almost impossible for a thief to use stolen card data to access an account associated with the card. Typically once a card has been skimmed the thieves will attempt to clear the account as fast as possible before the theft is realized and the card cancelled. Once this happens the card becomes useless and the thieves dispose of it to destroy the evidence. By making use of the invention it is possible to safely pass through this time window without any loss of funds and without having to cancel a card. By making use of the automatic “OFF” feature a thief may attempt to access an account without success and is likely to quickly dispose of, what the thief is likely to believe, is a card that has already been cancelled at the bank that issued it. It may then not even be necessary for the card owner to cancel his card.

It will be appreciated that the embodiment described above is given by way of example only, and is not intended to limit the scope of the invention. Specifically, it is not intended to limit the scope of the invention Apple iPhone models which operate on a specific version of the Apple operating system (the “iOS”), or to a specific version of Apple device. The invention is equally applicable to later versions of these, which at the time of lodging this application extends up to iOS version 4.3 and the iPhone 4™. The invention is similarly applicable to other mobile communication devices from the Apple company, including the iPad1™ and iPad2™, and future versions thereof, and future versions of iPhones™.

Similarly, the invention is also applicable to devices from other mobile communication device manufacturers which use different operating systems from that of Apple. These include, without limitation, the Android® and Symbian® systems.

It should be appreciated that where it is stated that the card is activated or deactivated, it is in reality the specific permission in respect of the account associated with the card on the remote server that is changed. To the user of the payment card it appears that it is the card that has been activated or deactivated, either entirely or for selected types of transactions or geographical areas. However, when the user uses one of the activation or deactivation buttons on the mobile device he actually sets the corresponding permission for such a transaction with respect to the relevant account on the remote server. If the status of any feature, as shown on the device, is shown as “YES”—in other words that such a transaction is allowed—then the corresponding permission is set on the remote server with respect to the account, and vice versa for when it is set as “NO” on the device.

1. A method of operating a mobile communication device to communicate with a remote server comprising:
providing by means of software operated on the mobile device means to input data relating to a payment card,
authenticating the data relating to the payment card with an authentication authority, and
providing by means of the software at least means to selectively set permissions on the remote server in respect of an account associated with the card.

2. The method claim 1 further comprising activating the card for control through the software by means of the software on the mobile device.

3. The method claim 0 wherein authenticating further includes authenticating the data relating to the payment card with the financial institution that issued the payment card.

4. The method claim 0 wherein authenticating the data relating to the card further includes transmitting a data carrying signal which includes data relating to at least the card number to the authentication authority, receiving on the mobile device a data carrying confirmation signal transmitted from the authentication authority to the mobile communication number associated with the card, the data signal including an authentication code, accessing the authenticating code by means of the software and transmitting, from the mobile device a data carrying signal which includes at least the card number and the authentication code signal to the server.

5. The method n claim 0 wherein authenticating code is accessed by the software on the mobile device within a predetermined time from receiving the authentication code on the mobile device.

6. The method claim 0 further comprising storing the authentication code in storage means associated with the mobile device and associating the authentication code with at least the card number.

7. The method of claims of claim 0 further comprising selectively activating or deactivating the card by setting permissions with respect to the account on the remote server, which operatively activates or deactivates the card for transactions in respect of the account.

8. The method of claim 0 wherein selectively activating or deactivating the payment card further comprises provision of input means to select an “ON” or “OFF” status, in which selecting “ON” sets the status of the card as activated and selecting “OFF” sets the status of the card as deactivated at the remote server, which sets corresponding permissions on the server in respect of the associated account.

9. The method as claim 0 wherein selectively activating or deactivating the payment card includes provision of means to selectively activate or deactivate the payment card with respect to predetermined utilization areas, the utilization areas including point of sale, automatic teller machine, online transactions, and geographical limitations.

10. The method claim 9 further including providing input means to select an “ON” or “OFF” status in respect of each of the predetermined utilization areas.

11. The method of claim 0 further comprising providing selection means to operate the mobile device to transmit a data carrying signal to the server requesting a status update in respect of account balances of an account associated with the card, receiving a data carrying signal from the server which includes data relating to the account balances, and processing the data to display the account balances on the display screen of the mobile device.

12. The method claim 11 further including requesting a status update in respect of a ledger balance and an available balance.

13. The method of claim 0 further comprising providing selection means to operate the mobile device to transmit a data carrying signal to the server requesting a status update in respect of the current account limits of an account associated with the card receiving a data carrying signal from the server which includes data relating to the current account limits, and processing the data to display the current account limits on the display screen of the mobile device.

14. The method claim 13 further including requesting a status update in respect of daily and monthly account limits.

15. The method of claim 0 wherein at least part of the data carrying signals is transmitted in the form of short message service signals.

16. The method of claim 0 wherein the mobile communication device is operable by means of the iOS™ operating system from the Apple™ company.

17. The method of claim 0 wherein the mobile communication device is operable by means Symbian™ Android™ or Blackberry™ mobile communication device operating systems.

18. A system which comprises a mobile communication device iterating the method as claimed in claim 0 and at least a server configured to complimentary operate with respect to the mobile communication device.

19. A mobile communication device configured to operate a set of software instructions to perform the method of claim 0.

20. Software which includes code configured to operate a mobile communication device to perform the method of claim 0.
